(19) United States
(12) Patent Application Publication
(10) Pub. No.: US 2008/0240334 A1
(43) Pub. Date: Oct. 2, 2008

(54) FUEL ELEMENTS FOR NUCLEAR REACTOR SYSTEM

(75) Inventors: David J. Senor, West Richland, WA (US); Chad L. Painter, West Richland, WA (US); Kenneth J. Geelhood, Richland, WA (US); David W. Wootan, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute

(21) Appl. No.: 11/859,105

(22) Filed: Sep. 21, 2007

Related U.S. Application Data
(60) Provisional application No. 60/909,236, filed on Mar. 30, 2007.

(51) Int. Cl. G21C 3/58

(52) U.S. Cl. 376/416

(57) ABSTRACT

A fuel element for nuclear power generation made up of at least one coated UO₂ fuel kernel embedded in a matrix containing Zr. The kernel and the element each having a coating that provides desired spacing and fission product barrier protection. The fuel enables the functioning and deployment of small scale nuclear reactors with a various features desired for deployment of such devices in developing nations, with limited electrical distribution infrastructure.

### PRIORITY

This invention claims priority from a provisional patent application entitled Fuel Elements for Nuclear Reactor Systems and Methods for Making Same having an application Ser. No. 60/909,236 filed on Mar. 30, 2007.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

1. Field of the Invention

The invention generally relates to nuclear power systems and more particularly to fuels for nuclear power systems.

2. Background of the Invention

The need for power plants capable of providing large baseline loads for use on well-developed electricity grids has historically driven the development of nuclear power reactors. As a result, most units and designs in this arena are large 1000+ MWe commercial units. Potential markets with much smaller power needs and less well-developed electrical distribution infrastructure, such as those found in developing nations, have not typically been considered in the design of nuclear power reactors and surrounding technologies.

A different reactor design, tailored for this developing nation market segment, could assist in helping meet the rising power demands associated with economic growth and urbanization, while limiting or avoiding the use of fossil fuels. In 2005, the US Department of Energy began developing program elements associated with what would be announced in 2006 as the Global Nuclear Energy Partnership (GNEP). As part of President Bush's Advanced Energy Initiative, GNEP seeks to develop a worldwide consensus on enabling the expanded use of economical, carbon-free nuclear energy to meet growing electricity demand.

An aim of GNEP is to provide small reactors suitable for meeting the growing energy demands of emerging economies in developing nations that currently depend on oil and other fossil fuels. Smaller-scale, passively-safe, secure and proliferation-resistant reactors are necessary before nuclear energy is viable for use in developing nations with small-grid markets. Such a device must meet a variety of criteria, it must be proliferation-resistant, passively-safe, and economical for potential deployment to nations with emerging economies. The present invention is a fuel that enables such a small scale reactor to be designed and utilized.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present invention is a small-scale, safe, proliferation-resistant fuel that can be used in a variety of applications including in small scale nuclear reactors that could be deployed in nations with emerging economies for the generation of carbon-free electricity. In its simplest form, the invention includes a fuel element made up of a fuel kernel, having a preselected fuel kernel material covered with a fission product barrier coating. This coated kernel is them embedded into a matrix to form a fuel element that is then preferably provided with an outer protective coating. The configurations and materials that make up the kernel, the fission product barrier, the matrix and the outer protective coating are selected and configured so as to produce a material that is resistant to corrosion, tampering, and undesired energy release.

An embodiment of the present invention such as the one set forth in the detailed description is designed to operate continuously over the proposed life of the reactor, which is typically intended to last at least some 20-40 years. Thus, a reactor that utilizes this type of fuel will not need refueling over its anticipated lifetime. This fuel is also designed to operate in a system where any produced fission products are retained, and wherein small temperature increases across the fuel radius are experienced.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 is a perspective view of a first preferred embodiment of the present invention.

FIG. 1a is a detailed view of a portion of the embodiment shown in FIG. 1.

FIG. 2 is a cut plan cut away view of the embodiment of the invention shown in FIG. 1.

FIG. 2a is a detailed view of a portion of the embodiment shown in FIG. 2.

FIG. 3 is a view of a process diagram for applying the outer coating portion in one embodiment of the present invention.

### DETAILED DESCRIPTION OF THE INVENTION

The following description includes the preferred best mode of one embodiment of the present invention. It will be clear from this description that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood that there is no intention to limit the invention to the specific form disclosed, but, on the contrary, the invention is to cover all modifications, alternative constructions, and equivalents falling within the spirit and scope of the invention as defined in the claims.

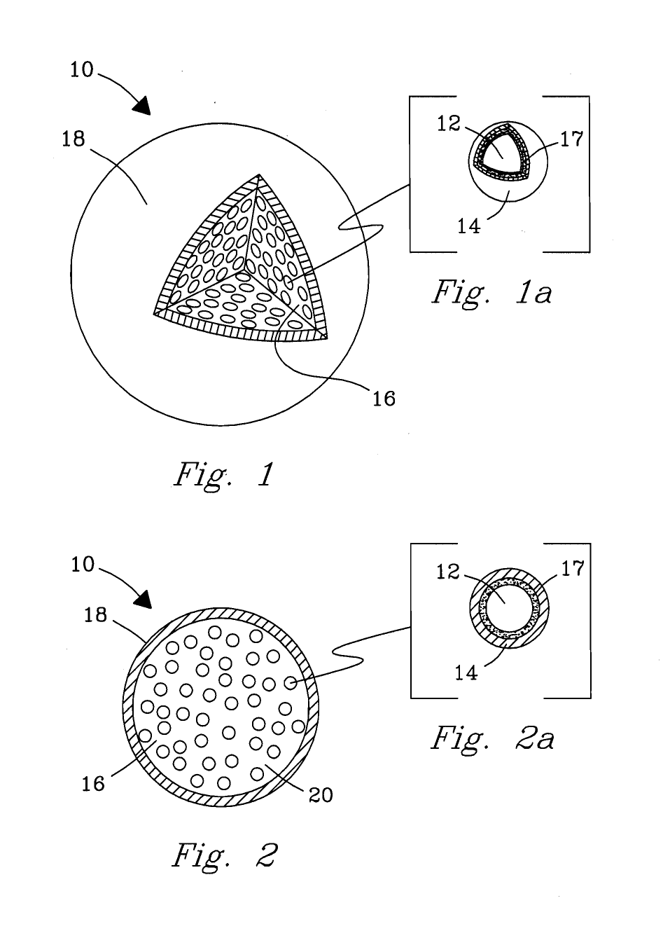

The preferred embodiment is a fuel designed for use in a small-scale, contained, proliferation-resistant nuclear reactor that could be utilized for example, in nations with emerging economies for the generation of carbon-free electricity. FIGS. 1-3, show a variety of views of this preferred embodiment of the present invention, and methods related to the manufacture of such an embodiment.

Referring first to FIGS. 1, 1a, 2 and 2a various views of an embodiment of the present invention are shown. These figures show a generally spherically shaped fuel element (SFE) or pebble 10, that incorporates small and dense fuel kernels 12, coated with a Zr or Zr based coating 14, typically between 25-50 μm thick and packed within a matrix 16. These kernels 12 are preferably about 100-500 μm in diameter, consist of low-enriched UO₂ (i.e. less than 20% ²²⁵U) and create heat via a controlled nuclear fission reaction. The matrix 16 is preferably a zirconium, or zirconium hydride matrix that is over coated with a protective outer zirconium or zirconium alloy fuel-free layer 18. The spherical fuel elements (SFE) 10 in such an embodiment are intended to be generally spherical in size with a diameter of 10-15 mm, however it is be distinctly understood that while specific designations are recited the invention is not limited thereto but may be variously embodied to include a variety of shapes, sizes, and materials all of which are contemplated by the scope of the invention which is set forth in the claims.

In the preferred embodiment of the invention, the individual fuel kernels 12 have a thin coating 14 that acts as a first fission product barrier and establishes a minimum separation distance between kernels 12 to avoid hot spots in the fuel. This kernel coating 14 also helps regulate the kernel packing fraction when these kernels are ultimately consolidated into larger SFEs or “pebbles” 10. Preferably, the coatings 14 on the kernels 12 are made from Zr and Zr alloys however other materials may also be utilized depending upon the particular needs and necessities of the user.

The coated kernels are embedded in a dense matrix to form a generally spherical fuel element, SFE or pebble 10. In the preferred embodiment of the invention the pebble 10 is typically about 10-15 mm in diameter, however various modifications to this size of the pebble are anticipated within the scope of the present invention. The matrix 16 of the pebble provides a second fission product barrier. In the preferred embodiment of the invention a generally porous spacing buffer layer 17 extends between the fuel kernel 12 and the coating on the outer surface 14. In the preferred embodiment of the invention this porous buffer layer 17 contains zirconium however it is to be distinctly understood that the invention is not limited thereto but may be various embodied and configured according to the needs and necessities of the user.

The pebble outer surface 18 is preferably coated with a corrosion-resistant zirconium alloy such as Zr-1% Nb. This outer coating 18 is preferably a Zr-alloy coating about 150-300 μm thick and will provide a third fission product barrier and protect the fuel-bearing portion of the pebble from the primary coolant. One of the functional advantages of the spherical fuel element 10 described here relative to more traditional light water reactor fuels is high effective thermal conductivity due to the small UO₂ kernels, metallic matrix and coatings, and lack of pellet-to-cladding gaps.

The Zr-coated kernels 12 are embedded in a dense Zr or ZrHₓ matrix 16 to form a spherical pebble 10. The fuel element matrix 16 must maintain its structural integrity throughout the life of the fuel element. The pebble outer surface is coated with a layer coating 18 of Zr or Zr-base alloy to provide an additional fission product barrier and protect the fuel-bearing portion of the pebble 10 from the primary coolant within the reactor in which the fuel elements are placed. The primary advantage of the spherical fuel element 10 relative to more traditional light water reactor fuels is the high thermal conductivity due to the small UO₂ kernels 12, metallic matrix 16 and coatings 14, 18, and lack of pellet-to-cladding gaps. Kernel packing fractions of 0.3 to 0.5 are preferable, but the optimal size and packing fractions may be varied depending upon the particular needs and necessities of the user. The Zr based matrix 16 provides low neutron absorption and minimal transmutation. Similarly, the Zr based kernel coating 14 and Zr based outer coating 18 provide desired levels of compatibility with the fuel, matrix and coolant. The thickness of the Zr based coatings 14, 18 may be altered according to the desired kernel packing fraction and the desired minimum kernel separation. Other factors such as the acceptable material loss due to corrosion and wear during the life of the pebble 10 may also have an effect upon the thickness of the outer coating 18.

In other embodiments of the invention, other materials may be utilized for these coatings 14, 18. In the preferred embodiment a radiation-stable ZrH_{1.6}, device may be utilized. In this embodiment the ZrH_{1.6} matrix has a higher thermal conductivity than Zr and can be utilized in larger pebbles 10 while retaining the desired thermal characteristics. In addition, a wide range of other materials could also be utilized as coatings 14, 18. These include materials such as Ti and V, alloys such as Ti-6Al-4V or V-4Cr-4Ti, stainless steel and Zircaloy, ceramics such as carbides (SiC, TiC, ZrC, NbC, TaC, WC), nitrides (AlN, TiN, CrN, NbN), oxides (Y₂O₃-stabilized ZrO₂ and MgAl₂O₄), CVD diamond, and nanolayered composites incorporating multiple ceramic coating layers. Other materials may also be considered and incorporated into the outer coating 18. The coating 14 on the surface of the fuel kernel 12 is preferably placed by chemical vapor deposition (CVD). However, other methods for placing this coating 14 may also be utilized.

In one embodiment of the invention the kernels 12 are made from 9% enriched UO₂ and have a diameter of about 500 μm. These kernels 12 are then coated with a zirconium buffer layer 17 and then covered with a Zr or Zr alloy 14 and placed within a matrix 16 made of a similar material, preferably containing Zr. The kernels 12 are packed in the matrix 16 in a density of about 10.7 g/cm³, and at a kernel packing fraction of about 0.3. The pebbles of SFE 10 are generally about 10 mm in diameter and are coated with a Zr covering 18 of about 0.03 cm in thickness. While the aforementioned parameters have been provided it is to be distinctly understood that the invention is not limited thereto but may be variously configured according to the needs and necessities of a user.

In this described embodiment of the invention, these spherical fuel elements 10 provide structural stability over a service life of at least 20 years, high thermal conductivity, low fuel temperature operation, good fission product retention, high burn up potential, and other desired features. Various modifications to the size, location, placement, composition and characteristics of the kernels, the coatings, the matrix, and the pebbles could all have an effect upon the reactivity and effect of the device.

In addition to various modifications to the kernel and the SFE, various modifications to the arrangement of these elements into a reactor core can also be made so as to influence the actions of the device in a particular way. For example, there are various ways to extend the core life time of the unit. These include increasing the amount of fuel in the core, increasing the fuel kernel packing fraction and increasing the core size. The use of fuel enrichment zoning is another way of increasing core lifetime and fuel utilization efficiency. The inclusion of an appropriate burnable poison or absorber 20 in the SFE 10 can also flatten the radial power profile and prolong the useful life of such a device. In some embodiments of the invention, the inclusion of a reflector made from a material such as beryllium may also be utilized to flatten the radial power distribution in the core. Separate coolant flow channels may also be used to flatten the radial power distribution and increase core life.

In embodiments where a burnable absorber is utilized, such an absorber 20 should be compatible with the fuel, matrix, structural, and coolant materials. It should not produce undesirable transmutation products, and should have a neutron absorption level such that it completely burns out over the core lifetime without leaving significant residual negative reactivity. Various examples of burnable absorbers 20 include gadolinium, erbium, boron, and europium. While the aforementioned materials are provided it is to be distinctly understood that the invention is not limited thereto but may be variously embodied to include a variety of other materials as burnable absorbers in various embodiments of the invention. These absorbers 20 can be mixed and included in a variety of locations within the fuel including within the fuel kernel 12 as well as within the coatings 14, and within the matrix 16. The preferred embodiment of the invention incorporates europium in the form of EuO₂ in the UO₂ kernels, in the amount of 0.5 weight percent.

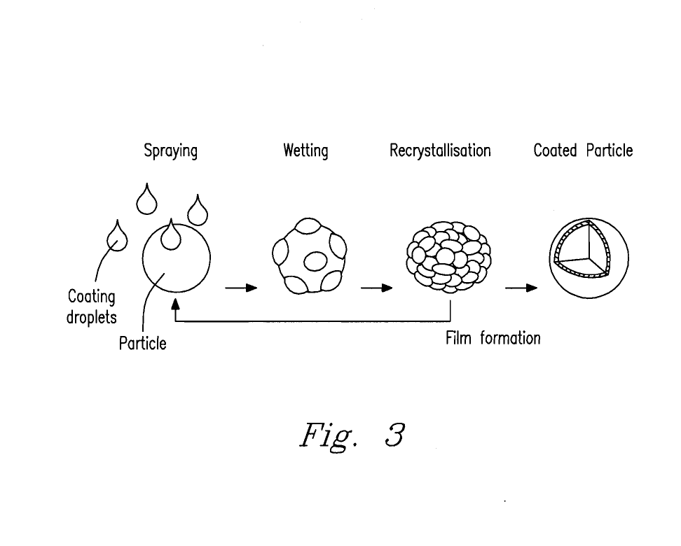

The formation of the kernels 12 of the present invention can be performed by a variety of methods, but most probably by well-understood sol-gel processes to produce a dense UO₂ kernel having a preselected size and shape. The placement of the previously described thin coats of material 14 upon the kernels 12 is preferably performed through a process such as chemical vapor deposition (CVD). This chemical vapor deposition is preferably accomplished through the use of a fluidized bed chemical vapor deposition process (FBCVD) in which a flowing gas imparts fluid-like properties to the particles, causing them to move relative to each other and to be uniformly exposed to a coating precursor and to a heated zone. A non-reactive fluidizing gas is used in sufficient flow to allow movement of the particles within the bed without causing them to be blown out of the bed. Along with the non-reactive gas, a reactant precursor gas is introduced that will chemically produce the desired coating on the surface of the particles by the thermal decomposition process. Heating of the fluidized bed of particles is commonly accomplished using an inductive heating coil around the fluidized bed assembly. A process diagrams for applying a kernel coating is shown in FIG. 3.

The preferred approach for producing Zr-coated UO₂ fuel kernels is to utilize a Zr-halide precursor such as Zr I₄ or ZrBr₄ in a fluidized bed CVD reactor. In this method a fluidized bed of fuel kernels is inductively heated to the appropriate decomposition temperature and ZrI₄ or ZrBr₄ vapor is passed through the fluidized bed by an inert carrier gas. The inert gas is used in sufficient flow to allow movement of the particles within the bed without causing them to be blown out of the bed. Along with the nonreactive gas, a reactant precursor gas is introduced that will chemically produce the desired coating on the surface of the particles by the thermal decomposition process. Heating of the fluidized bed of particles is commonly accomplished using an inductive heating coil around the fluidized bed assembly. The Zr based coating 14 is then deposited upon the fuel kernels 12, which can be further processed to form the SFEs 10 of the present invention.

After the kernels 12 have been formed and a coating 14 placed upon them these items 12, 14 can be incorporated into a matrix 16 to form the SFE 10. In one embodiment of the invention the matrix is a ZrHₓ matrix where x=1.6, this produces a face-centered cubic phase at projected operating temperatures (300-400° C.). At these temperatures, the ZrH_{1.6} matrix is generally thermodynamically stable, thereby suffering little hydrogen loss and not requiring hydrogen barrier coatings. A preferred method for forming the SFE 10 is by pressing. For Zr-matrix pebbles, Zr powder could be mixed with the Zr-coated fuel kernels and hot pressed in a die to the desired dimensions at a preselected time and temperature. While this configuration is indicated as one method for forming these particles it is to be distinctly understood that the invention is not limited thereto but may be variously embodied according to the needs and necessities of a user.

To prevent interaction between the primary coolant in the reactor, and the fuel kernels, a protective coating is typically utilized. The thickness and composition of the outer protective coating is therefore a function of its expected corrosion rate and the projected lifetime of the pebble in the primary coolant. In the preferred embodiment of the invention, a Zr or Zr alloy outer protective layer, in a thickness of between 150-300 μm should be sufficient to provide corrosion protection in the anticipated 300° C. liquid water. While a Zr or Zr alloy of the designated thickness is preferably used in the outer protective layer a variety of other types of materials may also be utilized. These materials include CVD-SiC, Y₂O₃-stabilized ZrO₂ (YSZ), titanium foil (Ti), tungsten foil (W), molybdenum foil (Mo), vanadium (V), and V-4Cr-4Ti alloy in an as-rolled condition.

While chemical vapor deposition from a fluidized bed is generally the preferred method for applying a coating to the fuel kernels, the thickness required for the outer coating layer 18 is provided by a different method. To apply this outer coating 18 to the entire SFE a low temperature spray process combined with a liquid phase sintering step to fully densify the resulting pebble coating will provide an acceptable approach to production of the outer protective layer. Coatings will be applied to the pebbles in a fluidized or vibratory bed to ensure initial uniform coverage prior to the sintering step. This method offers many advantages including the ability to apply thick and/or multiple layers of the coating material and the ability to produce alloys by appropriate preparation of the spray suspension mixture.

The SFEs 10 of the present embodiment can be utilized in the small scale nuclear reactors which have been discussed previously. In one embodiment of such a reactor, the Atoms for Peace Reactor (AFPR), a water-cooled fixed particle bed, randomly packed with spherical fuel elements SFE 10 approximately 10 mm in diameter provides power for the device. In addition, a cylindrical core approximately 3 m in height and 3 m in diameter, and including a series of four annular rings containing the spherical fuel elements is included within the device. The reactor core is cooled by single-phase upward water flow within the particle bed. The proposed mechanism for steam generation within such a system is by use of a steam generator outside the pressure vessel. In such a configuration, the preferred embodiment of the present invention allows a small scale proliferation resistant reactor to operate with a closed core that has upwards of a 20-year core life with moderate-to-high burnup (50-90 GW-d/MTU). In addition, these fuel elements 10 allow for low stored energy in the fuel, rapid thermal response, robust fission product containment, and simple core design.

A reactor that incorporates the materials of the present invention is low maintenance and proliferation resistant. The preferred embodiment of the present invention provides a fuel concept with a high burnup fuel, that would require significant development to reprocess, and significantly reduces or eliminates the need to open the pressure vessel during the 20-year core lifetime. The inclusion of the fuel of the preferred embodiment of the present invention allows for various design aspects of the original AFPR system to be simplified. For example, the elimination of in-core boiling coupled with the introduction of the cermet fuel elements also improves the moderator-to-fuel ratio so that moderator tubes are no longer necessary. In addition, the cermet fuel elements also eliminate the need to cycle fresh fuel into the core and spent fuel out of the core during the 20-year core lifetime. This then further simplifies the system design while allowing more fuel into the core.

The preferred embodiment of the invention allows for a small scale nuclear reactor that has the capability of producing 300 MW of thermal energy under the following conditions: core inlet temperature of 204° C., core exit pressure of 15 MPa, core exit subcooling of 16.7° C. below saturation at the core exit pressure, core pressure drop of 0.0564 MPa; total flow rate of 585 kg/sec, assuming 1.5% bypass flow; core exit temperature of 310° C.; steam generated at a pressure of 9.875 MPa. Depending upon the exact necessities of the user, the set up of the reactor or the fuels may be appropriately modified so as to achieve a preselected variable difference from these aforementioned parameters.

In this preferred utilization of the preferred embodiment of the invention, the actual fuel material within a 10-mm diameter SFE consists of approximately 2000 spherical kernels of UO₂ distributed essentially uniformly throughout a Zircaloy matrix. In such an embodiment the core can be operated within the desired range of conditions, with acceptable coolant and fuel temperatures in single-phase vertical up flow of light water. However, if these ideal conditions are compromised the composition of the fuel in the designed reactor retains the effects of the compromise in a self limiting manner. Thus the use of the present fuel allows for safe mediation of a variety of disruptive circumstances, including but not limited to losses of pumping power (e.g., station black-out, pump trip, turbine trip), and pipe rupture in the primary system (e.g., double-ended guillotine break in vessel inlet piping.)

The salient feature of all disruptive events of this type is a rapid loss of flow to the core or rapid system depressurization, or both, these incidents in turn would cause a sudden decrease in the ability of the system to remove heat from the core. The small particle size of the fuel in the core results in a much smaller amount of thermal energy being stored in the core at any given time under normal operating conditions. For example, the peak fuel center temperature is expected to be only 3-6° C. above the temperature at the fuel particle surface, compared to the 600-1000° C. temperature difference between the cladding surface and fuel centerline that is typical of fuel in commercial light water reactor cores during normal operations and off normal events. This lower temperature operation thus enables the heat that must be absorbed and convected away by the coolant is simply the heat generated in the fuel particles.

Because of the extremely low decay heat generated by the core, and the relatively low flow rate needed to cool the fuel particle bed, natural recirculation cooling could be a viable option for hot-shutdown conditions. It is anticipated that the core thermal output drops by 95% within 5 seconds of shutdown, from 300 MW to approximately 15 MW. In less than 24 hours, the total core thermal output is less than 1% of full power. The flow rate required to remove this extremely reduced thermal output is relatively small.

The previously described preferred embodiment of the present invention thus enables a small-scale, inherently safe, proliferation-resistant reactor that could be deployed in nations with emerging economies. The AFPR concept offers advantages over existing small reactors and concepts in that it has a long core life, is more proliferation resistant, and the technologies needed to build the reactor exist today. Preliminary neutronics, thermal-hydraulics, and fuel performance studies suggest that the proposed 10-15 mm diameter spherical cermet fuel element would be an ideal fuel for this reactor concept. The present fuel is believed to perform in-reactor for at least 20 years and up to 90 GWd/MTU.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A fuel element for nuclear power generation; said fuel element comprising:
at least one coated fuel kernel embedded in a matrix, said coated fuel kernel having a fission product barrier coating, said matrix also having a protective outer coating.

2. The fuel element of claim 1, wherein the fuel kernel comprises at least one material selected from the group consisting of UN, UC, (U, Pu)N, (U, Pu) C, Th—U fuels, UO₂, and combinations thereof.

3. The fuel element of claim 1, wherein the kernel is enriched less than 20%.

4. The fuel element of claim 1, further comprising a porous buffer between said kernel and said outer coating.

5. The fuel element of claim 1, further comprising a burnable absorber.

6. The fuel element as recited in claim 5, wherein the burnable absorber is selected from the group consisting of Gd, Er, B, Eu, and combinations thereof.

7. The fuel element as recited in claim 1, wherein the matrix comprises a metal as an element, an alloy, or a compound.

8. The fuel element as recited in claim 1, wherein the matrix comprises Zr.

9. The fuel element as recited in claim 1, wherein matrix comprises ZrHₓ.

10. The fuel element as recited in claim 9, wherein the matrix comprises ZrH_{1.6}.

11. The fuel element as recited in claim 1, wherein the fission product barrier coating comprises Zr.

12. The fuel element as recited in claim 1, wherein the outer protective coating comprises Zr.

13. The fuel element as recited in claim 1, wherein the outer protective coating comprises a Zr-based alloy.

14. The fuel element as recited in claim 1, wherein the outer protective coating is selected from the group consisting of V, V-4Cr-4Ti, T₁, Y₂O₃-stabilized ZrO₂, SiC, and Mo.

15. A method for fabricating a fuel element for nuclear reactor systems having at least one fuel kernel with a fission product barrier coating embedded in a matrix said matrix also covered by a protective outer coating, the method comprising the steps of:
applying a fission product barrier coating to the outer surface of fuel kernels;
embedding the fuel kernels in a matrix, wherein the matrix is formed into a shaped body; and
applying an outer protective coating to the shaped body.

16. The method as recited in claim 15, further comprising forming fuel kernels prior to applying a fission product barrier coating to said kernels.

17. The method as recited in claim 15, wherein said step of applying a fission product barrier coating includes utilizing a technique selected from the group consisting of chemical vapor deposition, physical vapor deposition, pulsed laser deposition, and combinations thereof.

18. The method as recited in claim 15, wherein said step of applying an outer protective coating includes spray coating the shaped body.

19. A fuel element for nuclear power generation; said fuel element comprising:
at least one coated UO₂ fuel kernel embedded in a matrix containing Zr, said coated fuel kernel having a fission product barrier coating, said matrix surrounded by a buffer layer and a protective outer coating.
